(19) United States
(12) Patent Application Publication
(10) Pub. No.: US 2018/0056412 A1
(43) Pub. Date: Mar. 1, 2018

(54) Circular to Table Saw Converter

(71) Applicant: Angel Mario Torres, Wylie, TX (US)

(72) Inventor: Angel Mario Torres, Wylie, TX (US)

(21) Appl. No.: 15/294,752

(22) Filed: Oct. 16, 2016

Related U.S. Application Data
(60) Provisional application No. 62/494,931, filed on Aug. 26, 2016.

(51) Int. Cl. B23D 47/02; B25H 1/04; B25H 1/10

(52) U.S. Cl. CPC B23D 47/025; B25H 1/10; B25H 1/04

(57) ABSTRACT

A device for mounting a circular saw may include a support base to support device and the circular saw; a detachably connected spacer device to provide variable cuts for the circular saw; a spacer arm to connect to the support base; and a traverse rail to connect to the spacer arm and to connect to the circular saw.

### PRIORITY

The present invention claims priority under 35 USC section 119 and provisional application 62/494,931 filed on Aug. 26, 2016.

### FIELD OF THE INVENTION

The present invention relates to circular saws and more particularly to a converter device to convert a circular saw to operate as a table saw.

### BACKGROUND

Table saws are an important device in cabinetry by providing for precision cuts in wood and other material. However, table saws may be large, heavy and cumbersome to transport from one location to another. These table saws may be required at a remote location in order to provide position cuts at the job location. These table saws may provide a long cut necessary in cabinetry. The standard table saw is renowned for splitting boards. In contrast, circular saws are portable and light weight and can be easily transported from one location to another location. Generally, the circular saws cannot provide the precision cut required for many jobs.

### SUMMARY

A device for mounting a circular saw may include a support base to support the converter and the circular saw; a detachably connected spacer device to provide variable cuts for the circular saw; a spacer arm to connect to the support base; and a traverse rail to connect to the spacer arm and to connect to the circular saw.

The traverse rail may be movable.

The traverse rail may be traversely connected to the spacer arm.

The traverse rail may be connected to the circular saw by a fastener.

The fastener may include an a first portion and a second portion which are detachably connected to each other.

The first portion may be substantially C shaped.

The second portion may be substantially L-shaped.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of the circular to table saw converter of the present invention;

FIG. 2 illustrates a side view of the circular to table saw converter of the present invention;

FIG. 3 illustrates a top view of the support base of the present invention;

FIG. 4 illustrates an end view of the support base of the present invention;

FIG. 5 illustrates a side view of the support base of the present invention;

FIG. 6 illustrates a top view of the movable spacer device of the present invention;

FIG. 7 illustrates a side view of the movable spacer device of the present invention;

FIG. 8 illustrates a top view of a spacer arm of the present invention;

FIG. 9 illustrates a side view of the spacer arm of the present invention;

FIG. 10 illustrates a bottom view of the spacer arm of the present invention;

FIG. 11 illustrates a top view of the traverse rail of the present invention;

FIG. 12 illustrates a side view of the traverse rail of the present invention;

FIG. 13 illustrates a side view of a portion of the fastener of the present invention;

FIG. 14 illustrates a top view of a portion of the movable fastener of the present invention;

FIG. 15 illustrates a front view of a portion of the movable fastener of the present invention;

FIG. 16 illustrates a side view of another portion of the movable fastener of the present invention;

FIG. 17 illustrates a front view of another portion of the movable fastener of the present invention;

FIG. 18 illustrates an end view of the spacer arm of the present invention.

### DETAILED DESCRIPTION

The present invention provides a portable saw converter that may be transported in a small vehicle for smaller jobs or stored in the garage for the occasional for small job use. The present invention provides a platform for standard circular saws being connected to the platform for woodcuts. The saw converter of the present invention is lightweight and is easy for all homeowners to manage. The saw converter of the present invention is adjustable and able to mount saws of varying sizes and can accommodate saws of various manufacturers. The circular to table saw converter of the present invention provides a platform to mount a circular saw for board rips.

The circular to table saw converter is very compact yet efficient for use in big jobs.

The bracket/fasteners are adjustable to accommodate different sizes and brands by being detachably connected of circular saws. The present invention includes two rails to lock into position for safe cutting. A board will be passed through the circular to table saw converter platform for a continuous cut along the board. The present invention includes a circular to table saw converter that provides the same function as a table saw with the additional benefits of being portable and the ease of storage. The circular to table saw converter of the present invention may be formed from substantially solid material such as metal including as aluminum or any other suitable material.

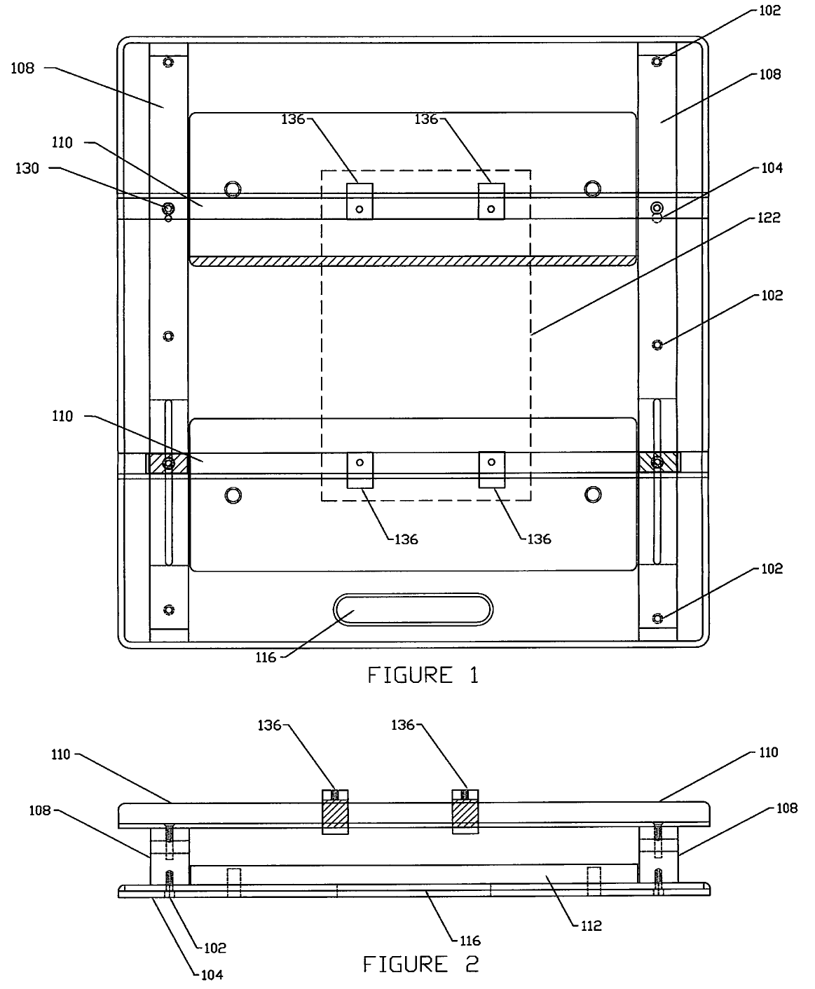

FIG. 1 illustrates a top view of the circular to table saw converter of the present invention and illustrates the support base 102 of the present invention which may include spacer apertures 104 to connect to the spacer arms 108 and which may include insert apertures 106 to cooperate with rods 114 of the spacer device 112 (a mirrored pair of spacer devices 112). FIG. 1 additionally illustrates a handle/slot 116 to allow the support base 102 to be carried. The support base 102 may be substantially rectangular, square, oval or other appropriate shape.

FIG. 1 additionally illustrates the support base 102 of the present invention which may include the spacer apertures 104.

FIG. 2 illustrates a side view of the support base 102 of the present invention which may include the insert apertures 106 and the handle/slot 116.

FIG. 1 illustrates the movable spacer device 112 of the present invention which may be substantially rectangular, square, oval or other appropriate shape and which an opposing pair of mounting apertures 118 to cooperate with a mounting rod 120 which may cooperate with the insert apertures 116 of the support base 102.

The movable spacer device 112 may be removed and replaced (detachably connected) by another spacer device 112 having a different thickness in order to control the depth of cut of the circular saw 122.

FIG. 2 illustrates a side view of the movable spacer device 112 of the present invention which may be substantially rectangular, square, oval or other appropriate shape and which an opposing pair of mounting apertures 118 to cooperate with a mounting rod 120 which may cooperate with the insert apertures 116 of the support base 102.

FIG. 1 illustrates a longitudinal spacer arm 108 of the present invention which may have a rectangular, square, oval or other shaped cross-section. Additionally, the spacer arm 108 may include spacer arm apertures 124 to allow connection with the fasteners attached to the traverse rails 110.

FIG. 2 illustrates a side view of the spacer arm of the present invention which illustrates the arm apertures 124 and illustrates a slot 126 to allow the traverse rails 110 to be moved longitudinally.

FIG. 1 illustrates the traverse rail 110 of the present invention and illustrates the traverse arm aperture 130 for connection to the spacer arm 108 and the notch 132 to allow the fastener (not shown) to fasten the traverse arm 110 to the spacer arm 108.

FIG. 2 illustrates a side view of the traverse rail 110 of the present invention and illustrates the traverse arm aperture 130 for connection to the spacer arm 108 and the notch 132 to allow the fastener (not shown) to fasten the traverse arm 110 to the spacer arm 108.

FIG. 2 illustrates a first portion 136 of the movable fastener of the present invention which may be substantially C shaped and may include a threaded aperture 138 through the top wall of the first portion 136 to cooperate with the second portion 140 of the movable fastener of the present invention and to accept a threaded bolt (not shown). The bottom wall of the movable fastener may cooperate with the traverse rail 110.

FIG. 1 illustrates a top view of a first portion 136 of the movable fastener of the present invention which may be substantially C shaped and may include a threaded aperture 138 through the top wall of the first portion 136 to cooperate with the second portion 140 of the movable fastener of the present invention and to accept a threaded bolt (not shown). The bottom wall of the movable fastener may cooperate with the traverse rail 110.

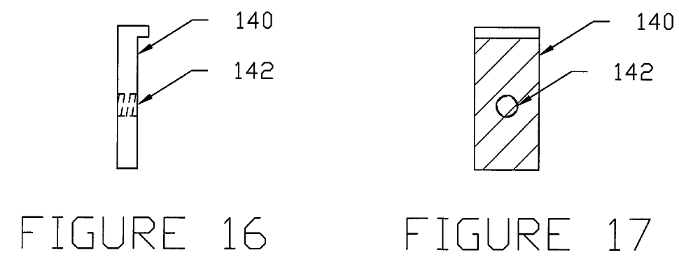

FIG. 16 illustrates a side view of another portion of the movable fastener 136 of the present invention;

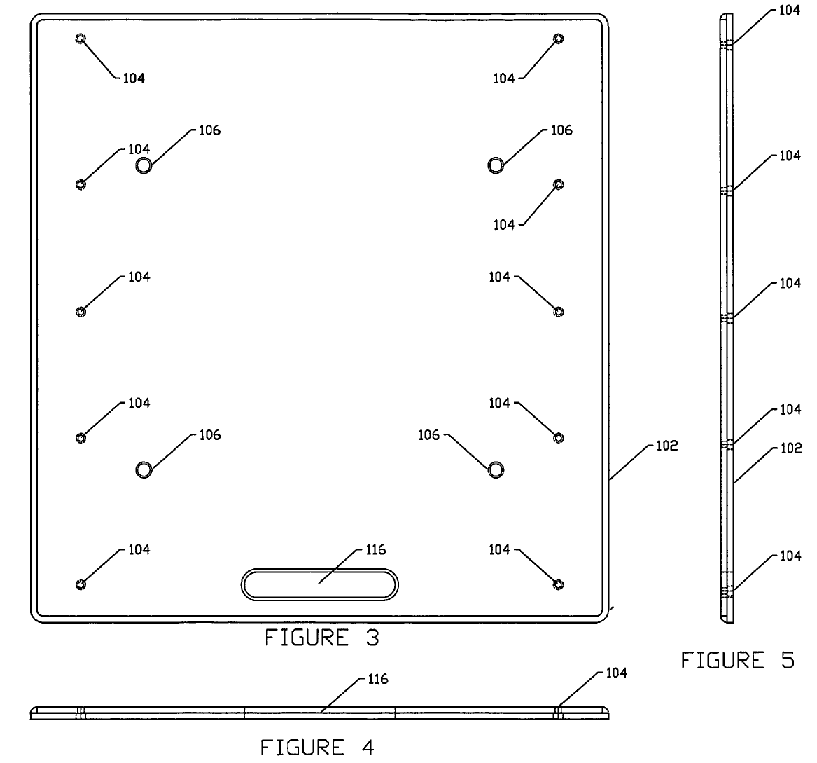

FIG. 3 illustrates a top view of the support base of the present invention which may include spacer apertures 104 to connect to the spacer arms 108 and which may include insert apertures 106 to cooperate with rods 114 of the spacer device 112. FIG. 3 additionally illustrates a handle/slot 116 to allow the support base 102 to be carried. The support base 102 may be substantially rectangular, square, oval or other appropriate shape.

FIG. 4 illustrates an end view of the support base 102 of the present invention which may include the spacer apertures 104.

FIG. 5 illustrates a side view of the support base 102 of the present invention which may include the insert apertures 106 and the handle/slot 116.

FIG. 6 illustrates a top view of the movable spacer device 112 of the present invention which may be substantially rectangular, square, oval or other appropriate shape and which an opposing pair of mounting apertures 118 to cooperate with a mounting rod 120 which may cooperate with the insert apertures 116 of the support base 102.

The movable spacer device 112 may be removed and replaced by another spacer device 112 having a different thickness in order to control the depth of cut of the circular saw 122.

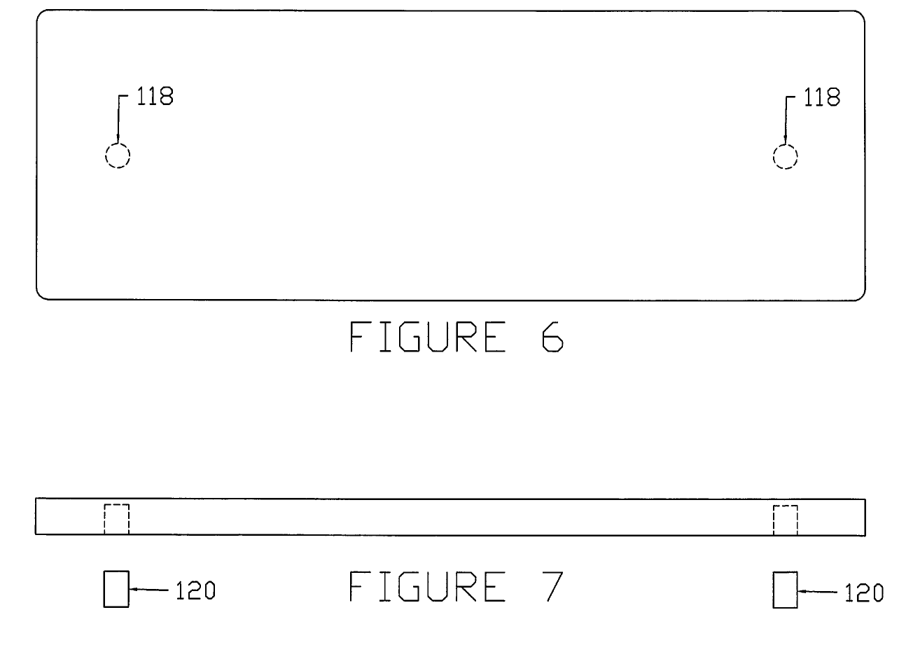

FIG. 7 illustrates a side view of the movable spacer device 112 of the present invention which may be substantially rectangular, square, oval or other appropriate shape and which an opposing pair of mounting apertures 118 to cooperate with a mounting rod 120 which may cooperate with the insert apertures 116 of the support base 102.

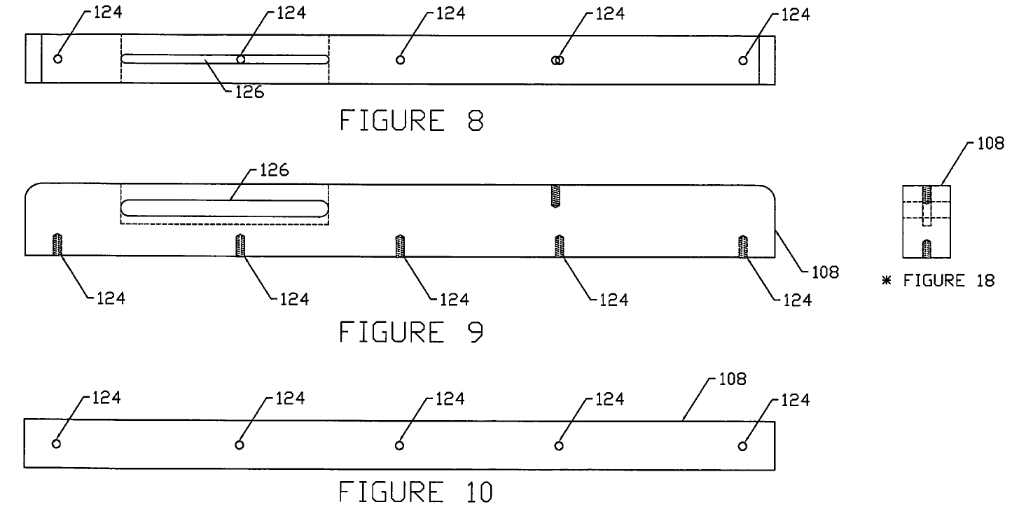

FIG. 8 illustrates a top view of a longitudinal spacer arm 108 of the present invention which may have a rectangular, square, oval or other shaped cross-section. Additionally, the spacer arm 108 may include spacer arm apertures 124 to allow connection with the fasteners attached to the traverse rails 110.

FIG. 9 illustrates a side view of the spacer arm of the present invention which illustrates the arm apertures 124 and illustrates a slot 126 to allow the traverse rails 110 to be moved longitudinally.

FIG. 10 illustrates a bottom view of the spacer arm 108 of the present invention and illustrates the arm apertures 124 and the slot 126.

FIG. 18 illustrates an end view of the spacer arm 108 of the present invention

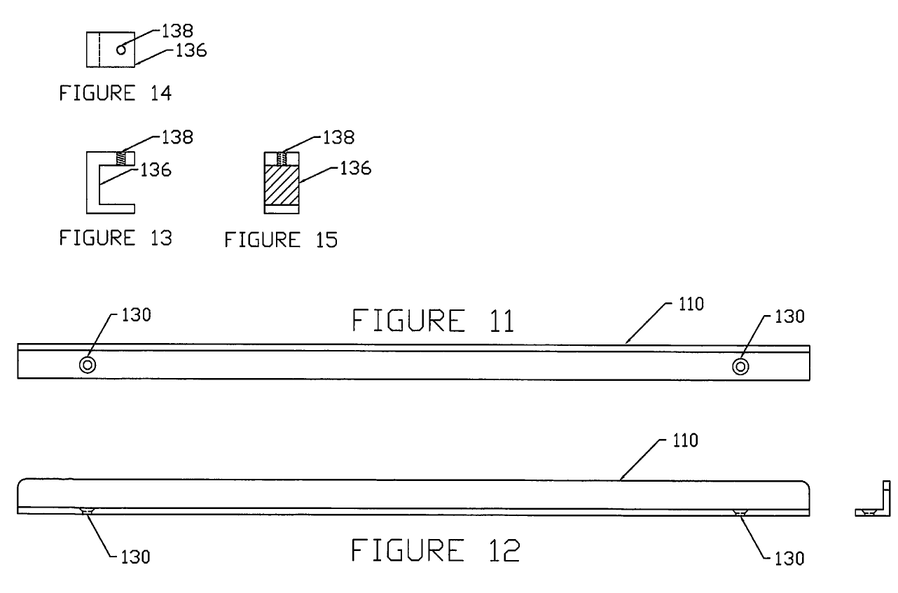

FIG. 11 illustrates a top view of the traverse rail 110 of the present invention and illustrates the traverse arm aperture 130 for connection to the spacer arm 108 and the notch 132 to allow the fastener (not shown) to fasten the traverse arm 110 to the spacer arm 108.

FIG. 12 illustrates a side view of the traverse rail 110 of the present invention and illustrates the traverse arm aperture 130 for connection to the spacer arm 108 and the notch 132 to allow the fastener (not shown) to fasten the traverse arm 110 to the spacer arm 108.

FIG. 13 illustrates a side view of a first portion 136 of the movable fastener of the present invention which may be substantially C shaped and may include a threaded aperture 138 through the top wall of the first portion 136 to cooperate with the second portion 140 of the movable fastener of the present invention and to accept a threaded bolt (not shown). The bottom wall of the movable fastener may cooperate with the traverse rail 110.

FIG. 14 illustrates a top view of a first portion 136 of the movable fastener of the present invention which may be substantially C shaped and may include a threaded aperture 138 through the top wall of the first portion 136 to cooperate with the second portion 140 of the movable fastener of the present invention and to accept a threaded bolt (not shown). The bottom wall of the movable fastener may cooperate with the traverse rail 110.

FIG. 15 illustrates a front view of a first portion 136 of the movable fastener of the present invention which may be substantially C shaped and may include a threaded aperture 138 through the top wall of the first portion 136 to cooperate with the second portion 140 of the movable fastener of the present invention and to accept a threaded bolt (not shown). The bottom wall of the movable fastener may cooperate with the traverse rail 110.

FIG. 16 illustrates a side view of another portion of the movable fastener of the present invention;

FIG. 17 illustrates a front view of a second portion 140 of the movable fastener of the present invention which may be L-shaped and may include a second threaded aperture 142 to cooperate with the bolt described above to clamp the circular saw 122 to the traverse rails 110.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A device for mounting a circular saw, comprising:
a support base to support device and the circular saw;
a detachably connected spacer device to provide variable cuts for the circular saw;
a spacer arm to connect to the support base;
a traverse rail to connect to the spacer arm and to connect to the circular saw.

2) A device for mounting a circular saw as in claim 1, wherein the traverse rail is movable.

3) A device for mounting a circular saw as in claim 1, wherein the traverse rail is traversely connected to the spacer arm.

4) A device for mounting a circular saw as in claim 1, wherein the traverse rail is connected to the circular saw by a fastener.

5) A device for mounting a circular saw as in claim 4, wherein the fastener includes a first portion and a second portion which are detachably connected to each other.

6) A device for mounting a circular saw as in claim 5, wherein the first portion is substantially C shaped.

7) A device for mounting a circular saw as in claim 5, wherein the second portion is substantially L-shaped.
